(19) United States
(12) Patent Application Publication
(10) Pub. No.: US 2026/0290146 A1
(43) Pub. Date: Sep. 24, 2026

(54) COMPUTERIZED SYSTEMS AND METHODS FOR DYNAMICALLY AND AUTOMATICALLY MANAGING A SECURITY SYSTEM

(71) Applicant: RESIDEO LLC, Golden Valley, MN (US)

(72) Inventors: Rajeev Padmanabha Pillai, Alappuzha (IN); Parul Malik, Prayagraj (IN)

(73) Assignee: RESIDEO LLC, Golden Valley, MN (US)

(21) Appl. No.: 19/138,352

(22) PCT Filed: Jul. 14, 2023
(86) PCT No.: PCT/US2023/070240

§ 371 Date: Jun. 12, 2025

(30) Foreign Application Priority Data
Dec. 21, 2022 (IN) 202241074234

(51) Int. Cl. G08B 25/00; G08B 29/18

(52) U.S. Cl. CPC G08B 25/008; G08B 29/18

(57) ABSTRACT

Disclosed are systems and methods that provide a novel framework for real-time management of a user's location based on real-world activities in order to automatically determine whether to toggle the operational modes of a security system (e.g., arm or disarm, for example). The disclosed framework can operate via an integrated, personalized configuration that enables the collective management of a location based on the sensors available from each device operating therein. The framework can automatically and dynamically toggle to the appropriate operational mode given the real-time activity occurring in/around the location.

### CROSS REFERENCE TO RELATED APPLICATION

This application claims the benefit of, and priority to, Indian Patent Application No. 202241074234, filed Dec. 21, 2022, its entirety of which is incorporated herein by reference.

### FIELD OF THE DISCLOSURE

The present disclosure is generally related to a security monitoring system, and more particularly, to a decision intelligence (DI)-based computerized framework that automatically and dynamically manages the operational modes a security system.

### BACKGROUND

The security industry faces many challenges arising from false alarms (also referred to as “false positives”). Most false alarms are typically end user related, in that they generally occur during the arming and disarming of a security system (e.g., the security control panel). Conventional arming/disarming of a system typically involves a user entering a security code into a control panel and/or application that is connected to the control panel (e.g., from their smartphone, for example). However, these capabilities are statistic, and do not account for real-world dynamics of how users (or occupants, used interchangeably) interact with their surroundings and/or function within their home/office during their daily lives.

### SUMMARY OF THE DISCLOSURE

To that end, according to some embodiments, the disclosed systems and methods provide a novel computerized security framework that provides functionality for the automatic and dynamic management of a security system at a location. In some embodiments, as discussed herein, a location can refer to any type of definable and/or confined geographic and/or physical area for which a security system can be applied, such as, not limited to, a home, office, building, yard and the like.

According to some embodiments, the disclosed framework can leverage a security system's connected and/or configurable sensors to detect when to disarm or disable the security system (or at least a sensor or zone associated therewith). In some embodiments, as discussed below, the sensors can be associated with security sensors, such as, for example, cameras, glass break detectors, motion detectors, door and window contacts, heat and smoke detectors, carbon monoxide (CO₂) detectors, passive infrared (PIR) sensors, and the like. In some embodiments, such sensors can also involve, in an Internet of Things (IoT) environments, lights, smart locks, garage doors, smart appliances (e.g., thermostat, refrigerator, television, personal assistants (e.g., Alexa®), Nest®, for example)), smart phones, smart watches or other wearables, tablets, personal computers, and the like, and some combination thereof.

Thus, as discussed herein, each sensor/detector in/around a location can be utilized to track user movements for purposes of managing specific modes of operation. Accordingly, in some embodiments as discussed herein, as users move in, around, about and out a location, their movements can trigger the security to be armed, disarmed and/or some combination thereof.

According to some embodiments, an operation mode (or operational mode, used interchangeably) of a security system can involve any type of known or to be known setting to secure and/or monitor a location, such as, but not limited to, armed, disarmed, stay, away, bypass, and the like. In some embodiments, the security system can include a set or plurality of zones, whereby each zone is associated with an account for a location. For example, the upstairs of a house can be zone 1, the front door and entry way can be zone 2, and the kitchen of the house can be zone 3, and the like.

Accordingly, in some embodiments, an operation mode can correspond to at least a portion of sensors/detectors at a location, and/or can correspond to at least one zone. Thus, in some embodiments, an operation mode can involve certain sensors being armed, while other sensors are disarmed or set to bypass. For example, when a security system is armed to “stay” mode, the sensors for the entry points to the house can be armed, while the motion detector inside the house can be set to bypass so as not to trigger an alarm for the occupant inside the home.

By way of a non-limiting example, according to some embodiments, a user is detected as walking towards their front door to exit their house. The disclosed framework, via the sensors of the location, can determine that it is safe to disarm the door contact sensor(s) associated with the front door (and in some embodiments, via automatic locks, unlock the front door). In some embodiments, such determination can be based on the framework determining that there is not another person (or animal) on the other side of the door, for example.

In some embodiments, for example, should another user be identified as being on the other side of the door, that user's identity can be verified (e.g., via facial recognition, as discussed below), whereby upon identifying the user as a known and safe user (e.g., as an occupant of the house), then the system can disarm appropriately.

Accordingly, when the user exits the disarmed front door, the framework can detect they exited the premises, and based on detected occupancy of the house (among other settings), the system can switch to another operational mode. For example, upon detecting other users remain in the house (e.g., via a motion detector, for example), the system can switch to “stay” mode. In another example, if no other users are detected in the house, the system can automatically switch to “away” mode.

Thus, according to some embodiments, the disclosed framework can enable the automatic arming and/or disarming of the a security system based on data indicating user movements and/or presence (or occupancy) within and around a location. As evident from the disclosure herein, this enables a more free-flowing security system that can adapt to the movement in/around the location without the manual requirement of arming/disarming.

According to some embodiments, a method is disclosed for automatically and dynamically controlling operational modes of a security system based on real-time detected events. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and dynamically controlling operational modes of a security system based on real-time detected events.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides a novel framework that can discern whether to arm and/or disarm a security system based on activity in/around the location. As discussed herein, in some embodiments, when a user is detected as attempting to access an entry point of a location (e.g., door, window and the like), the disclosed framework can analyze the information surrounding such access attempt and determine whether it is safe for the user (and/or the location) to grant such access by disarming the security system (at least respective to the sensors associated with that entry point).

For example, a house can have a capacitance sensor associated with a door handle on the inside of the house. Upon an occupant user attempting to exit the house, which is detected via a capacitance reading being collected by the user grabbing the door handle, the framework can determine if other users (e.g., known or unknown users) are physically proximate to that door. Thus, the framework can interpret the capacitance reading as a request to unlock the door and disarm the door contact, which can cause the framework to analyze other related sensor data to that physical space surrounding the door (e.g., what is occurring within the scannable area outside the door). For example, is a capacitance reading being detected from the handle on the other side of the door. In another example, are there other users detected as being on the porch (e.g., via a camera or motion detector, for example), and if so, are they known users. Should it be determined to be safe, as discussed herein, the security system can be disarmed and then safely re-armed, accordingly, after the user's detected exit.

In another non-limiting example, an occupant user is attempting to open their front door, where the security system's operational mode is armed to “away.” In some embodiments, for example, the framework can detect the capacitance on the door handle via the associated PIR sensor on the outside door handle. Upon detecting the capacitance, the framework can perform an identify check of the user (e.g., check their ID via some form of identity verification). For example, the system can automatically determine who they are based on a recognition mechanism, for example, facial recognition, biometrics, voice recognition, and the like, or some combination thereof. In another example, the framework can send the user a notification or request which can be used to confirm their identity.

For example, upon sensing the capacitance, the framework can capture an image of the user (via an associated camera connected to an outdoor PIR-motion sensor, for example), whereby the image is analyzed to determine the identify of the user. Should the user be determined to be an occupant, the door contact can be disarmed, the door can be automatically unlocked, and upon the user entering and closing the door, the system can be armed to “stay”.

Thus, as discussed herein, the disclosed framework enables an “on-the-fly” arming and disarming of a security system that enables occupant users secure and safe access to a location without the need to pause or stop to toggle operation modes. Indeed, the collected sensor data of the system can be utilized to manage which operation modes are activated, thereby providing an automated security system for a location.

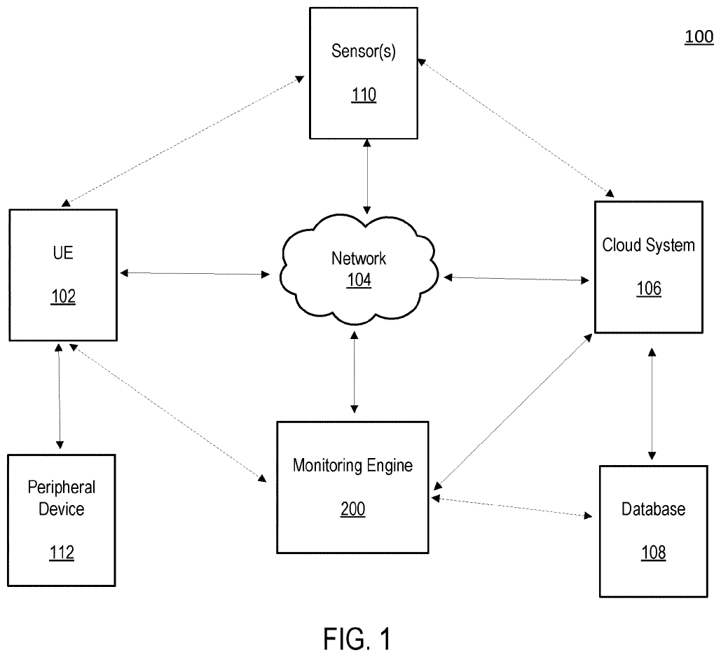

With reference to FIG. 1, system 100 is depicted which includes UE 102 (e.g., a client device, as mentioned above and discussed below in relation to FIG. 7), sensors 110, network 104, cloud system 106, database 108, monitoring engine 200 and peripheral device 112. It should be understood that while system 100 is depicted as including such components, it should not be construed as limiting, as one of ordinary skill in the art would readily understand that varying numbers of UEs, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver. In some embodiments, UE 102 can be a device associated with an individual (or set of individuals) for which security services are being provided. In some embodiments, UE 102 may correspond to a device of a security entity (e.g., a security provider, whereby the device can be and/or can have corresponding sensors 110, as discussed herein).

In some embodiments, peripheral device 112 can be connected to UE 102, and can be any type of peripheral device, such as, but not limited to, a wearable device (e.g., smart watch), printer, speaker, sensor, and the like. In some embodiments, peripheral device 112 can be any type of device that is connectable to UE 102 via any type of known or to be known pairing mechanism, including, but not limited to, Bluetooth™, Bluetooth Low Energy (BLE), NFC, and the like.

According to some embodiments, a sensors 110 can correspond to sensors associated with a location of system 100. In some embodiments, the sensors 110 can be associated with security sensors, such as, for example, cameras, glass break detectors, motion detectors, door and window contacts, heat and smoke detectors, CO2 detectors, PIR sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device 112 (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a security system provider, which has associated network resources hosted on the internet or private network (e.g., network 104), which enables (via engine 200) the security management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/device 112 and the UE 102/device 112, sensors 110, and the services and applications provided by cloud system 106 and/or monitoring engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

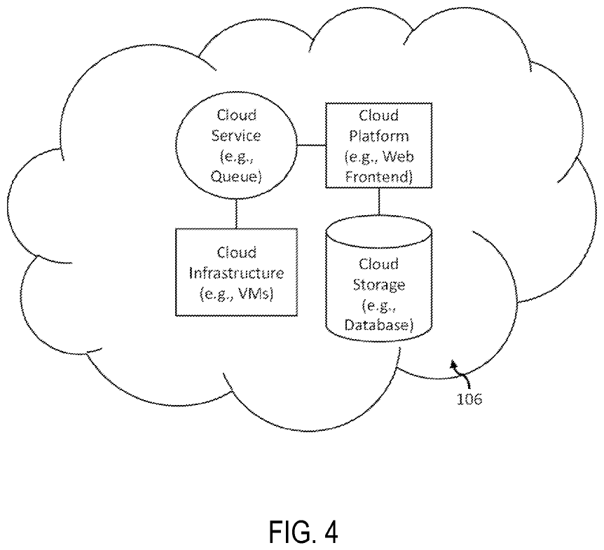

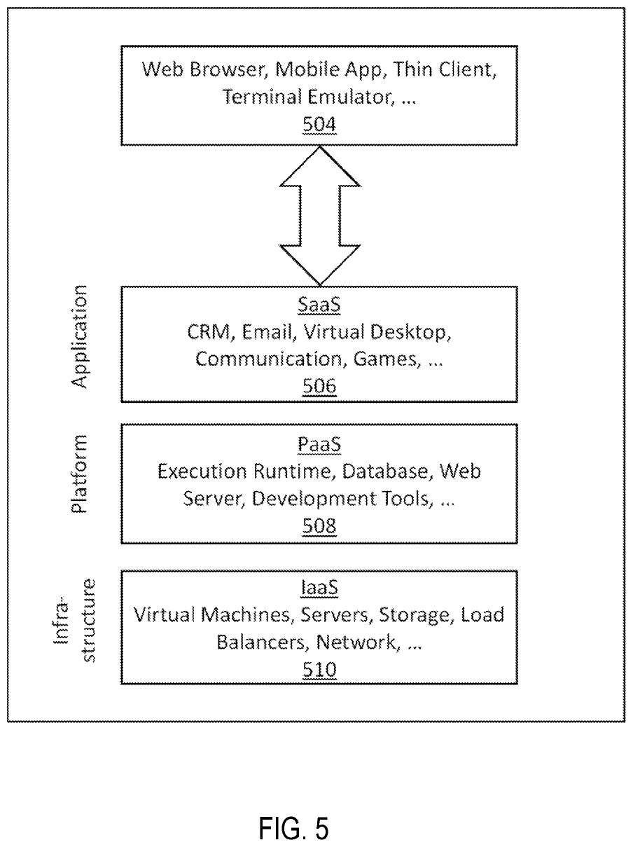

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 510, platform as a service (PaaS) 508, and/or software as a service (Saas) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 102 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Monitoring engine 200, as discussed above and further below in more detail, can include components for the disclosed functionality. According to some embodiments, monitoring engine 200 may be a special purpose machine or processor, and can be hosted by a device on network 104, within cloud system 106 and/or on UE 102 (and/or peripheral device 112). In some embodiments, engine 200 may be hosted by a server and/or set of servers associated with cloud system 106.

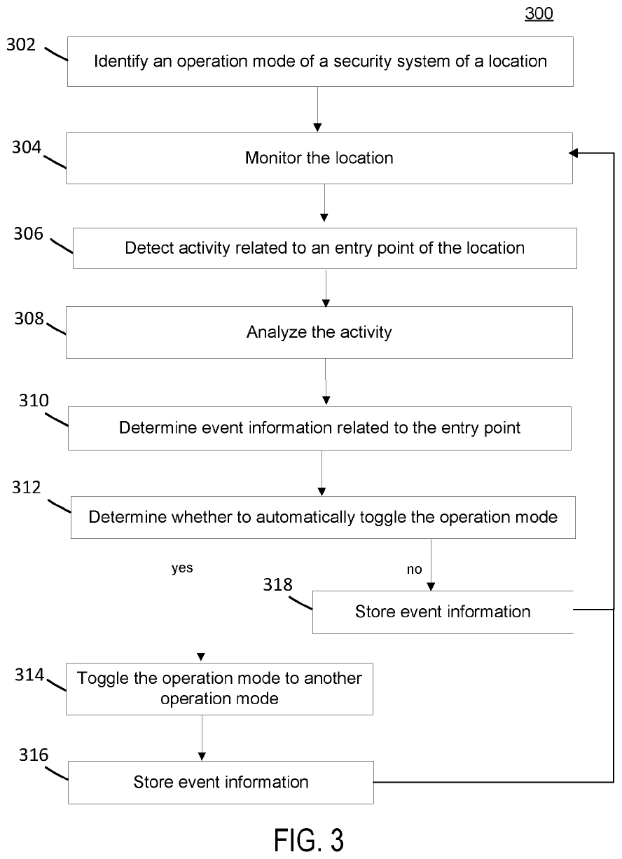

According to some embodiments, as discussed in more detail below, monitoring engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIG. 3.

According to some embodiments, as discussed above, monitoring engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or sensors 110.

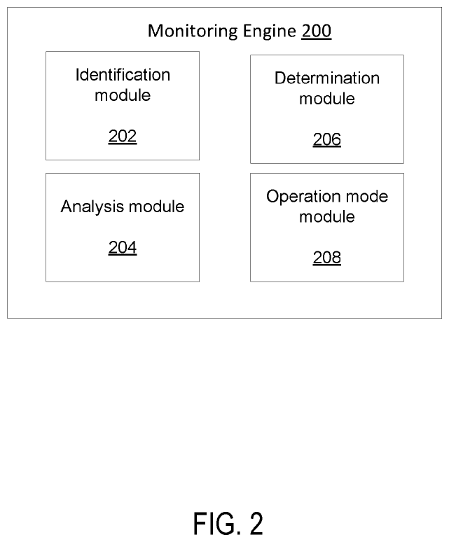

As illustrated in FIG. 2, according to some embodiments, monitoring engine 200 includes identification module 202, analysis module 204, determination module 206 and operation mode module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed security management framework. In some embodiments, as discussed herein, the disclosed framework can enable the automatic arming and/or disarming of the a security system based on data indicating user movements and/or presence within and around a location. As evident from the disclosure herein, this enables a personalized, dynamically applied security system that can adapt to the movement in/around the location without the manual requirement of arming/disarming.

According to some embodiments, Steps 302-306 of Process 300 can be performed by identification module 202 of monitoring engine 200; Step 308 can be performed by analysis module 204; Steps 310-312 can be performed by determination module 204; and Steps 314-318 can be performed by operation mode module 208.

According to some embodiments, Process 300 begins with Step 302 where identifies an operation mode of a security system at a location (e.g., a predefined physical/geographic location (e.g., a house or building), as discussed above). As discussed above, the operation mode can correspond to whether the security system is armed or disarmed, and/or a specific type of arming/disarming. For example, the operation mode can be armed in “away” mode; and in another non-limiting example, the operation mode can be armed in “stay” mode, with particular sensors assigned as “bypass” (e.g., motion sensor). Thus, in some embodiments, for purposes of discussion of Process 300, Step 302 can involve identifying an initial (or first) operational mode.

In Step 304, engine 200 can monitor the location in accordance with the operation mode (from Step 302). In some embodiments, engine 200 can monitor the location continuously, and/or according to a predetermined time interval. In some embodiments, the monitoring of the location can be performed via the location's sensors, as discussed above.

In some embodiments, a type and/or quantity of sensor data may be directly tied to the type of sensor. For example, a door contact sensor may only collect sensor data when a door is opened (e.g., an open event, which can indicate, but is not limited to, the identity of the door, time of opening, time of closing, duration of opening, quantity of opening, and the like, or some combination thereof). In another non-limiting example, a gyroscope sensor on a user's smartphone can detect when and in which direction a user is moving, the type and/or metrics of such movements.

In some embodiments, the monitoring can involve periodically pinging each or a portion of the sensors at the location, and awaiting a reply. In some embodiments, the monitoring can involve push and/or fetch protocols to collect sensor data from each sensor.

In Step 306, based on the monitoring of the location, engine 200 can detect activity related to an entry point of the location. As discussed above, an entry point can any type of area or pathway where access to and/or entry to the location is capable. For example, an entry point can be any type of known or to be known door or window (e.g., front door, garage door, and the like, for example). In some embodiments, the detection of the activity can involve a sensor or sensors associated with the entry point at the location detecting sensor data for an event, and electronically communicating that sensor data via the established connection with engine 200. For example, a motion detector sensor covering an area need the front door can detect movement by a user. In another example, as discussed above, a capacitance sensor associated with a door handle can detect a predetermined amount of capacitance that indicates a user has grabbed the door handle in an effort to open its associated door.

In some embodiments, such activity can include, but is not limited to, a user moving, an item moving, a door opening, and the like. In some embodiments, the activity may have to be performed according to a criteria including, but not limited to, a time, a date, a particular size, movements for a predetermined period of time (e.g., 3 seconds), movements at a certain speed (e.g., velocity and/or acceleration), movements at certain angles and/or trajectories, a location within the location (e.g., a sub-location), and the like, or some combination thereof.

According to some embodiments, information related to the activity can include, but is not limited to, a user's identity (ID), biometrics of the user, demographics of the user, position within the location (e.g., where in the house the user is, for example), movements of the user, which sensors are triggered by the event, climate in the location and/or outside the location, ID and/or number of other occupants at the location, current operation mode of the security system, and the like, or some combination thereof.

In Step 308, engine 200 can analyze the detected activity from Step 306. According to some embodiments, engine 200 can implement any type of known or to be known computational analysis technique, algorithm, mechanism or technology to analyze the collected sensor data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 310, based on the analysis from Step 308, engine 200 can determine an event information related to the entry point. The event information can correspond to a created data structure that includes information related to the collected sensor data, and the classification of such data, as discussed above in relation to Steps 306-308. According to some embodiments, the compilation of such event information can indicate which action is being detected, the metrics associated therewith, and the surrounding details related to such action(s). For example, in some embodiments, the event information for collected sensor data can correspond to, but is not limited to, a type of detected activity, a time of day, a date, type and/or ID of user, duration of activity, amount of activity, quantity of movements, sublocations within the location (e.g., rooms in the house, for example), and the like, or some combination thereof. According to some embodiments, the event information can be stored in database 108, as discussed above.

By way of example, event information related to user attempting to open a door can include information related to, but not limited to, ID of the door, ID of the user, presence data of other users or animals on the other side of the door, presence/occupancy data of other users in the location, and the like, or some combination thereof. Thus, the event information can be a compilation of analyzed sensor data related to a plurality of sensors serving an area of the location associated with the entry point.

In Step 312, the event information can be analyzed by engine 200, whereby a determination can be made regarding whether to toggle the operation mode to a different operation mode. That is, as discussed above, Step 312 can involve determining whether to disarm or arm the security system (or portions thereof) based on the activity detected in Step 306.

In some embodiments, engine 200 can perform Step 312 via execution of any of the known or to be known ML/AI techniques discussed above. For example, engine 200 can execute a computer vision algorithmic technique to determine whether a captured digital representation of another user on the outside of a door that is being attempted to be opened by another user from the inside is an occupant of the home. In another non-limiting example, engine 200 can determine whether the motion sensor outside the house has been triggered, thereby preventing the door from being disarmed automatically (e.g., without user permission).

Accordingly, in some embodiments, when engine 200 determines that it is not safe to change the operation mode, processing can proceed from Step 312 to Step 318, where the operation mode maintains its current status, and the event information is stored. Accordingly, processing can recursively operate to continue its monitoring of the location (which may have been operating in the backend). In some embodiments, Step 318 can additionally involve sending a request message to the user (or another administrative, occupant user of the location) requesting approval or instructions for an operation mode change).

For example, if a user is attempting to gain entry to their house via the front door, the system can determine if another user is proximate to their position (e.g., behind them). This can be determined via one of the sensors associated with the front door (e.g., motion detector, camera, and the like, for example). Should another person be detected as being near (e.g., within a predetermined distance to the user (e.g., 5 feet)), then engine 200 can determine not to automatically enable the operation change.

According to some embodiments, when engine 200 determines that it is safe to change the operation mode, processing can proceed from Step 312 to Step 314, where engine 200 can automatically toggle the operation mode to another operation mode. As discussed above, this can range from disarming the entire system, or setting the door contact for the entry point to “bypass,” for example.

Thus, for example, upon no other user being detected in the proximate area of an entry point of a location, engine 200 may engage the automatic functionality of toggling the operation mode to enable an unencumbered entry/exit of the location. In another example, if another user is detected, yet computer vision analysis identifies them also as an occupant, then engine 200 can still engage the operation mode change.

In Step 316, engine 200 can store the event information and proceed to continued monitoring of the location, as discussed above.

In some embodiments, such continued monitoring, via the processing of Process 300 engaged via the recursive processing after Step 316 (or Step 318) can enable a follow-on operation mode change that continues the sequence of the detected activity via Step 308. For example, if a user gains entry to their home via automatic toggling of the operation mode from “away” to “disarm”, upon them entering the home and closing the door, the system can detect the door close event and arm the system to “stay,” as discussed above.

In another non-limiting example, a user is determined to have safely left their home (e.g. switch from “stay” to “disarm,” for example). However, engine 200 detects that their smartphone is not with them (e.g., detected as being in another room via the IoT connectivity, as discussed above). Therefore, engine 200 may determine that the user will be reentering to get their smartphone, thus the system may not engage the operation mode of “away” (e.g., via a recursive performance of Step 312 and Step 318), and can maintain the operational mode as disarm. However, if it is detected that the user does not return (e.g., according to a time threshold and/or motion detection that the user has left the property, for example), the framework, via engine 200, can automatically engage Step 314 recursively.

Thus, the disclosed systems and methods provide novel mechanisms for automatically and dynamically controlling access to a location via real-time analysis of event data occurring in and/or around the location.

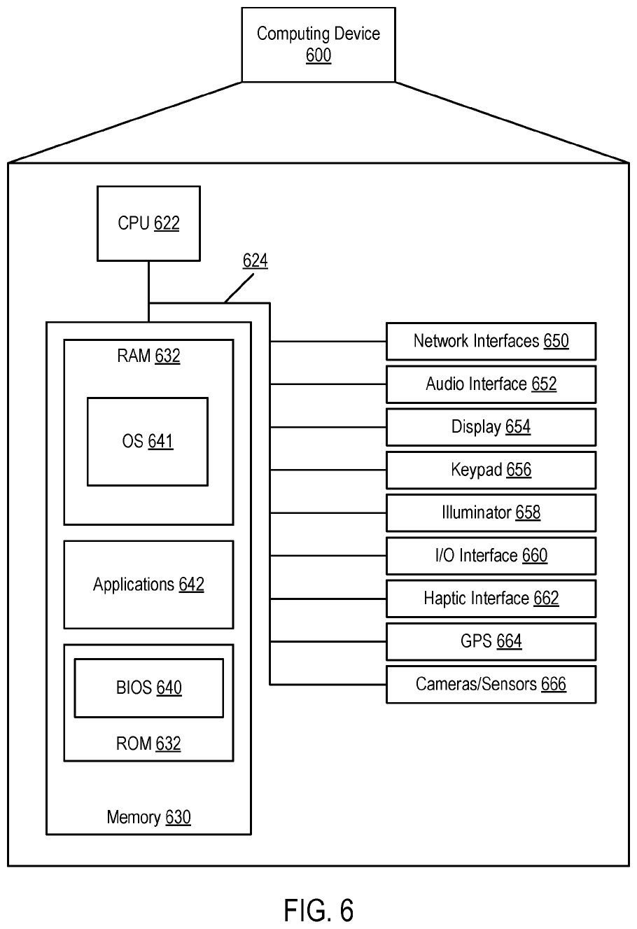

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™M, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, Javascript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
identifying, by a device, a first operation mode of a security system associated with a location, the security system comprising a plurality of sensors and detectors positioned in and around the location, each sensor operating in accordance with parameters dictated by the first operation mode;
detecting, by the device, via at least one of the plurality of sensors, activity related to an entry point of the location;
analyzing, by the device, activity, and determining, based on the analysis, event information, the event information comprising data related to an involve user and movements of the user in relation to the entry point;
determining, by the device, based on the event information, to change the first operation mode to a second operation mode; and
automatically switching, by the device, the security system from the first operation mode to the second operation mode based on the change determination.

2. The method of claim 1, further comprising:
determining, based on the event information, to maintain the first operation mode of the security system, wherein the maintain determination is based on the event information comprising information indicating unsafe conditions for disarming at least a portion of the security system.

3. The method of claim 2, wherein the unsafe conditions correspond to at least an unknown entity positioned on opposite side of the entry point.

4. The method of claim 1, further comprising:
detecting, after switching to the second operation mode, additional activity related to the entry point;
determining, by the device, based on the event information, to change the second operation mode to a third operation mode; and
automatically switching, by the device, the security system to the third operation mode.

5. The method of claim 4, wherein the third operation mode corresponds to a “stay” mode, wherein at least an interior motion detector is disarmed and the remained of the sensors are armed.

6. The method of claim 1, wherein the activity corresponds to a user attempting to enter the location.

7. The method of claim 1, wherein the activity correspond to a user attempting to exit the location.

8. The method of claim 7, further comprising:
detecting, via at least one of the plurality of sensors, occupancy data after the user exits the location, occupancy data corresponding to detected activity of other users in the location; and
automatically switching the security system to “stay” mode based on the occupancy data.

9. The method of claim 1, wherein the entry point corresponds to a door, wherein the activity is detected via at least a sensor associated with the door.

10. The method of claim 1, wherein the entry point corresponds to a window, wherein the activity is detected via at least a sensor associated with the window.

11. A device comprising:
at least one processor configured to:
identify a first operation mode of a security system associated with a location, the security system comprising a plurality of sensors and detectors positioned in and around the location, each sensor operating in accordance with parameters dictated by the first operation mode;
detect, via at least one of the plurality' of sensors, activity related to an entry point of the location;
analyze the activity, and determine, based on the analysis, event information, the event information comprising data related to an involve user and movements of the user in relation to the entry point;
determine, based on the event information, to change the first operation mode to a second operation mode; and
automatically switch, by the device, the security system from the first operation mode to the second operation mode based on the change determination.

12. The device of claim 11, wherein the processor is further configured to:
determine, based on the event information, to maintain the first operation mode of the security system, wherein the maintain determination is based on the event information comprising information indicating unsafe conditions for disarming at least a portion of the security system.

13. The device of claim 11, wherein the processor is further configured to:
detect, after switching to the second operation mode, additional activity related to the entry point;
determine based on the event information, to change the second operation mode to a third operation mode; and
automatically switch the security system to the third operation mode.

14. A non-transitory computer-readable storage medium tangibly encoded with computer-executable instructions that when executed by a device, perform a method comprising:
identifying, by the device, a first operation mode of a security system associated with a location, the security system comprising a plurality of sensors and detectors positioned in and around the location, each sensor operating in accordance with parameters dictated by the first operation mode;
detecting, by the device, via at least one of the plurality of sensors, activity related to an entry point of the location;
analyzing, by the device, activity, and determining, based on the analysis, event information, the event information comprising data related to an involve user and movements of the user in relation to the entry point;
determining, by the device, based on the event information, to change the first operation mode to a second operation mode; and
automatically switching, by the device, the security system from the first operation mode to the second operation mode based on the change determination.

15. The non-transitory computer-readable storage medium of claim 14, further comprising:
determining, based on the event information, to maintain the first operation mode of the security system, wherein the maintain determination is based on the event information comprising information indicating unsafe conditions for disarming at least a portion of the security system.

16. The non-transitory computer-readable storage medium of claim 14, further comprising:
detecting, after switching to the second operation mode, additional activity related to the entry point;
determining, based on the event information, to change the second operation mode to a third operation mode; and
automatically switching the security system to the third operation mode.

17. The non-transitory computer-readable storage medium of claim 16, wherein the third operation mode corresponds to a “stay” mode, wherein at least an interior motion detector is disarmed and the remained of the sensors are armed.

18. The non-transitory computer-readable storage medium of claim 14, wherein the activity corresponds to a user attempting to enter the location.

19. The non-transitory computer-readable storage medium of claim 14, wherein the activity correspond to a user attempting to exit the location.

20. The non-transitory computer-readable storage medium of claim 19, further comprising:
detecting, via at least one of the plurality of sensors, occupancy data after the user exits the location, occupancy data corresponding to detected activity of other users in the location; and
automatically switching the security system to “stay” mode based on the occupancy data.
